(19) United States
(12) Patent Application Publication
(10) Pub. No.: US 2012/0114160 A1
(43) Pub. Date: May 10, 2012

(54) TUNABLE EARPHONE

(75) Inventor: YOU-RUEI LIN, Tu Cheng (TW)

(73) Assignee: Cheng Uei Precision Industry Co., LTD., Tu Cheng City (TW)

(21) Appl. No.: 12/942,883

(22) Filed: Nov. 9, 2010

(51) Int. Cl. H04R 1/10

(52) U.S. Cl. 381/380

(57) ABSTRACT

Provided is a tunable earphone, including an earphone shell, a sound generation device and a tuning device. The earphone shell disposes a pivot hole and a number of tuning holes. The sound generation device is located in the earphone shell. The tuning device includes a tuning member and a damping body. The tuning member includes a covering body being adjustable for covering all or part of the tuning holes and a connecting rod. One end of the connecting rod is fixedly connected to the covering body, and the other end of the connecting rod extends out of the earphone shell. The damping body is placed into the corresponding tuning hole for auxiliary adjusting the pressure of the low sound inner cavity, so that the present tunable earphone can generate the different sound effect of the low frequency to satisfy the different users' needs.

### BACKGROUND OF THE INVENTION

1. Field of the Invention

The present invention relates to an earphone, and more particularly to a tunable earphone.

2. Description of the Prior Art

With the development of science and technology, electronic products are continuous upgraded. In order to assure that users can listen to the sound generated by the electronic product under the state of not interfering with others, a headphone is served as a necessary accessory of the electronic product. As shown in FIG. 1, a prior earphone 100′ comprises a shell 10′, a sound generation device 12′ and a damping object 14′. The sound generation device 12′ is located in the shell 10′ and a resonant cavity (not labeled in FIG. 1) is defined between the sound generation device 12′ and the shell 10′. The shell 10′ includes a low sound shell 101′ and a high sound shell 102′ covering unto the low sound shell 101′. The sound generation device 12′ and the high sound shell 102′ define a high sound inner cavity 11′. The sound generation device 12′, the high sound shell 102′ and the low sound shell 101′ define a low sound inner cavity 13′. In order to adjust the low frequency sound generated by the sound generation device 12′ for making the low frequency sound match with the high frequency sound, the damping object 14′ can be fixed on one end of the low sound shell 101′. Moreover, the material of the damping object 14′ can be changed for adjusting the low frequency sound and making the low frequency sound match with the high frequency sound, thereby making the sound be good to listen and tuning the sound effect.

However, it is well known that ears or meatus of everybody exist a small difference and everybody has his own taste for music. But because the damping object 14′ of the prior earphone 100′ is fixed in the low sound shell 101′ and cannot be freely replaced, an ordinary consumer can only receive the sound effect produced by the earphone after once purchase it.

### BRIEF SUMMARY OF THE INVENTION

An object of the present invention is to provide a tunable earphone, capable of smoothly tuning the sound effect of the low frequency.

To achieve the above object, in accordance with the present invention, a tunable earphone is provided, comprising an earphone shell, a sound generation device and a tuning device. The earphone shell disposes a pivot hole and a number of tuning holes. The sound generation device is located in the earphone shell. A resonant cavity is defined between the earphone shell and the sound generation device. The tuning device comprises a tuning member and at least one damping body. The tuning member includes a covering body being adjustable for covering all or part of the tuning holes and a connecting rod. The covering body is corresponding to the tuning holes and is mounted on the inside of the earphone shell. One end of the connecting rod is fixedly connected to the covering body, and the other end of the connecting rod passes through the pivot hole to extend out of the earphone shell. The damping body is placed into the corresponding tuning hole.

Based on the above description, the tunable earphone of the present invention employs the covering body to adjustably cover all or part of the tuning holes, and employs a damping body placed into the corresponding tuning hole to auxiliary adjust the pressure of the low sound inner cavity. Whereby the tunable earphone of the present invention can generate the different sound effect of the low frequency to satisfy the different users' needs.

### BRIEF DESCRIPTION OF THE DRAWINGS

FIG. 1 is a schematic structure view of an earphone of the prior art;

FIG. 2 is a perspective view of a tunable earphone according to one embodiment of the present invention;

FIG. 3 is an exploded perspective view of the tunable earphone of FIG. 2;

FIG. 4 is a partial sectional view of the tunable earphone of FIG. 2; and

FIG. 5 is a frequency response graph of the tunable earphone of FIG. 2 in use.

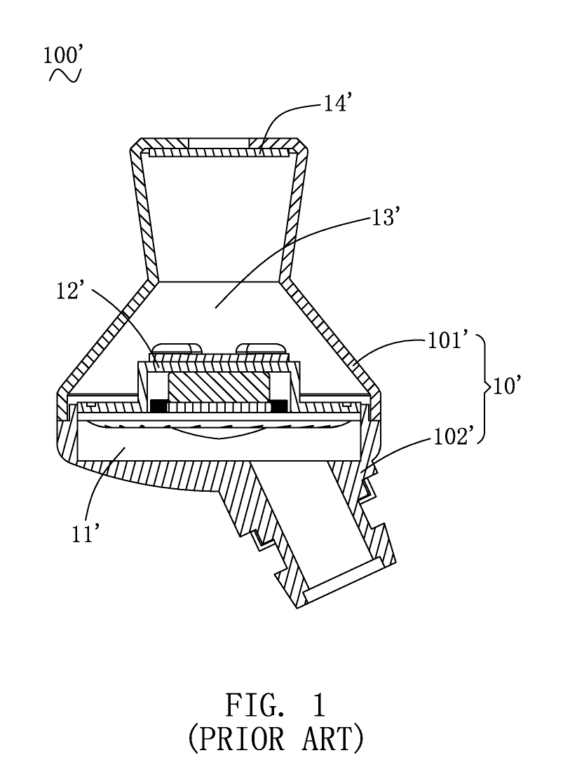

### DETAILED DESCRIPTION OF THE PREFERRED EMBODIMENTS

The following embodiment with reference to the accompanying drawings now has been given for detail describing the technology, the feature, the object and the effect of the present invention.

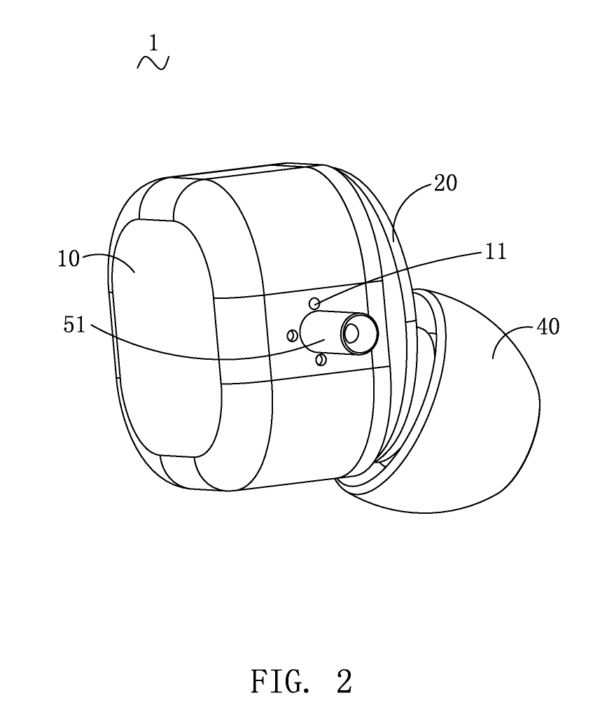

Referring to FIGS. 2 to 4, a tunable earphone of the present invention comprises an earphone shell, a sound generation device 30 located in the earphone shell, an ear cap 40 mounted on one end of the earphone shell, and a tuning device 50. The earphone shell and the sound generation device 30 together define a resonant cavity 60, 70. Specifically, the earphone shell comprises a low sound shell 10 and a high sound shell 20 covering unto the low sound shell 10. The sound generation device 30 and the high sound shell 20 together define a high sound inner cavity 60. The sound generation device 30, the high sound shell 20 and the low sound shell 10 together define a low sound inner cavity 70.

The high sound shell 20 forms a sound hole 21 on a back end thereof. A cover 22 is fixedly connected to a back portion of the sound hole 21 and forms a number of air holes 220 to communicate the high sound inner cavity 60 with atmosphere. The earphone shell disposes a number of tuning holes 11. Specifically, the tuning holes 11 are formed on the low sound shell 10 to make the low sound inner cavity 70 be communicated with atmosphere. The outside air follows can pass through the air holes 220 and the tuning holes 11 to separately enter into the high sound inner cavity 60 and the low sound inner cavity 70, thereby adjusting the air pressure of the resonant cavity and obtaining the needed sound effect. It needs to be noted that the number, shape and size of the air holes 220 and the tuning holes 11 can be determined by the actual needs. In one embodiment, the low sound shell 10 disposes a pivot hole 12 provided for holding the tuning device 50. There are four tuning holes 11 being symmetrically arranged around the pivot hole 12 on the low sound shell 10.

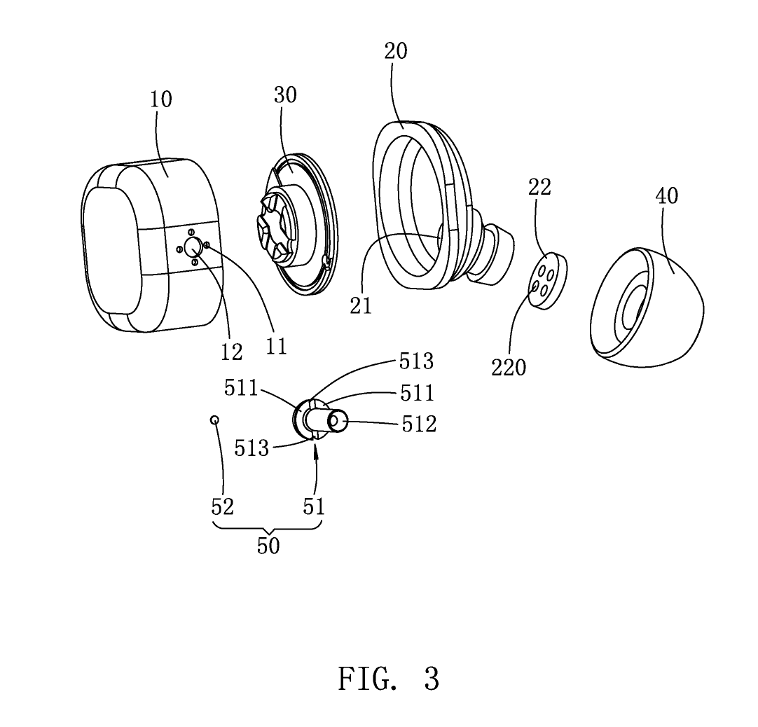

Continuously referring to FIG. 3, the tuning device 50 comprises a tuning member 51. The tuning member 51 includes a covering body 511 being adjustable for covering all or part of the tuning holes 11, and a connecting rod 512. The covering body 511 is mounted on the inside of the low sound shell 10 and is corresponding to the tuning holes 11. One end of the connecting rod 512 is fixedly connected to the covering body 511, and the other end thereof passes through the pivot hole 12 to extend out of the earphone shell. When rotating the connecting rod 512 of the tuning device 50, the connecting rod 512 brings the covering body 511 to be synchronously rotated so that the covering body 511 rotatably covers all or part of the tuning holes 11. In one embodiment, the tunable earphone is a wire earphone, and correspondingly the connecting rod 512 is a hollow pipe, namely a wire-receiving pipe, which can contain the wires connecting the tunable earphone and an electrical product. The one end of the connecting rod 512 is center-symmetrically extending outward to form two covering bodies 511, and two gaps 513 are formed between the two covering bodies 511. The two covering bodies 511 also can constitute the wire-receiving pipe and is used as a holding portion of the low sound shell 10.

The tuning device 50 further comprises at least one damping body 52, which is corresponding to the tuning holes 11, is disc shaped, and is made of the air-permeable material such as metal mesh, nylon cloth and so on. The damping body 52 is crammed into the corresponding tuning hole 11.

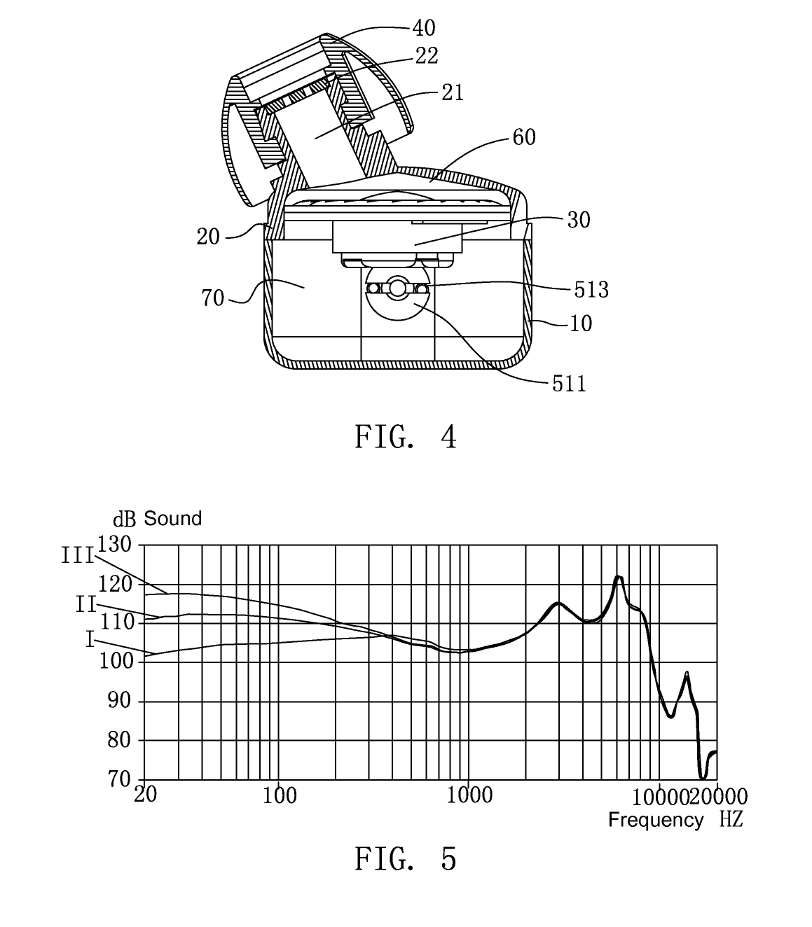

Referring to FIG. 5, which shows the changes of the frequency curve of the tunable earphone when the covering body 511 rotates to the different locations. Particularly, the graph of FIG. 5 shows that the present tunable earphone is response to the sound under the different covering states of the tuning holes 11 in the frequency range, as 20 HZ to 20 KHZ, of human auditory. As shown in FIG. 4, when the two covering bodies 511 are separately aligned with two of the tuning holes 11 for closing the two tuning holes 11, the two gaps 513 are separately aligned with the other two tuning holes 11, and the damping body 52 is not placed into the corresponding tuning hole 11, so that the air following can be caused to have a proper change to tune the sound volume of the low frequency, the frequency response curve of the low sound is shown as a first curve I of FIG. 5. When the damping body 52 is placed into the corresponding tuning hole 11, the two covering bodies 511 are separately aligned with two of the tuning holes 11, and the two gaps 513 are separately aligned with the other two tuning holes 11, the frequency response curve of the low sound is shown as a second curve II of FIG. 5. When the damping body 52 is placed into the corresponding tuning hole 11, the two covering bodies 511 are not aligned with the tuning holes 11, but covers all of the tuning holes 11, the frequency response curve of the low sound is shown as a third curve III of FIG. 5. It is obvious from the graph of FIG. 5 that the tunable earphone of the present invention employs a tuning device 50, which is disposed on the low sound shell 10, to generate the different sound effect of the low frequency and make the sound of the low frequency be more delicate under the condition of assuring the high frequency to be outstanding.

As described above, the tunable earphone of the present invention can rotate the connecting rod 512 of the tuning device 50 to bring the covering body 511 to be synchronously rotated so that the covering body 511 adjustably covers all or part of the tuning holes 11. Moreover, the tuning holes 11 are crammed with the damping body 52 to auxiliary adjust the pressure of the low sound inner cavity 70. Therefore, the tunable earphone of the present invention can generate the different sound effect of the low frequency to satisfy the different users' needs.

Furthermore, the above embodiment is used to specify the principle of the tunable earphone of the present invention. Namely, the connecting rod 512 drives the covering body 511 to adjust the location of the covering body 511 for covering the tuning holes 11. In the actual manufacture, the covering body 511 can be varied according to the number, shape and size of the tuning holes 11. For example, the covering body 511 may be a plate structure, or a block structure, or other structures. The covering body 511 also may be a ring-shaped structure for covering all the tuning holes 11.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A tunable earphone comprising:
an earphone shell, disposing a pivot hole and a number of tuning holes;
a sound generation device, being located in the earphone shell, wherein the earphone shell and the sound generation device together define a resonant cavity; and
a tuning device, comprising a tuning member and at least one damping body, wherein the tuning member includes a covering body being adjustable for covering all or part of the tuning holes and a connecting rod, the covering body is corresponding to the tuning holes and is mounted on the inside of the earphone shell, one end of the connecting rod is fixedly connected to the covering body, the other end of the connecting rod passes through the pivot hole to extend out of the earphone shell, and the damping body is placed into the corresponding tuning hole.

2. The tunable earphone as claimed in claim 1, wherein the covering body is extending outward from the one end of the connecting rod, and at least one gap is formed on the covering body.

3. The tunable earphone as claimed in claim 1, wherein the connecting rod is a hollow pipe.

4. The tunable earphone as claimed in claim 1, wherein the damping body is made of the air-permeable material.

5. The tunable earphone as claimed in claim 1, wherein the earphone shell comprises a low sound shell and a high sound shell covering unto the low sound shell, the sound generation device and the high sound shell together define a high sound inner cavity, the sound generation device, the high sound shell and the low sound shell together define a low sound inner cavity, and the tuning hole and the pivot hole are formed on the low sound shell.

6. The tunable earphone as claimed in claim 5, wherein the high sound shell forms a sound hole on one end thereof, and one end of the sound hole is fixedly connected to a cover, which forms a number of air holes to communicate the high sound inner cavity with atmosphere.
